(19) United States
(12) Patent Application Publication
(10) Pub. No.: US 2017/0334123 A1
(43) Pub. Date: Nov. 23, 2017

(54) MANUFACTURING A CONTOURED PLASTIC CONTAINER WITH PRINTING THEREON

(71) Applicant: Luv n' care, Ltd., Monroe, LA (US)

(72) Inventor: Nouri Edward Hakim, Monroe, LA (US)

(73) Assignee: Luv n' care, Ltd., Monroe, LA (US)

(21) Appl. No.: 15/525,743

(22) PCT Filed: Oct. 9, 2015
(86) PCT No.: PCT/US15/54984

§ 371 Date: May 10, 2017

(51) Int. Cl. B29C 49/06; B29C 49/20; B29C 49/24

(52) U.S. Cl. CPC B29C 49/06; B29C 2049/2431; B29C 49/24; B29C 2049/2017

(57) ABSTRACT

A contoured container such as a training cup for a toddler having a pinched-waist shape includes printing on the outer surface in a highly contoured portion. Before the manufacturing steps wherein a preform is expanded to the desired pinched-waist shape, it is printed using expandable or rubberized ink. This intermediate product of manufacture is then stretch blown to the final shape, and during this step, the ink expands along with the preform to result in a container with printing on the highly-contoured surface.

### FIELD OF THE INVENTION

The disclosed subject matter relates to the manufacture of plastic containers, typically sized for liquid transportation and human consumption, having contoured surfaces. An embodiment concerns the manufacture of a container forming part of a training cup for a toddler.

### BACKGROUND

Training cups for toddlers for the past many years have had a lid which joins with a container portion. Usually the lid contains a spout and an air vent, and the lid attaches to the container by threads or a snap configuration. Frequently the container has a non-uniform shape. That is, the container is not a uniform cylinder of rotation with a constant radius or diameter but instead is somewhat cylindrical but with a generally pinched waist. This pinched waist is easier for a toddler, with small hands, to grasp and hold. Such cups are generally made of plastic material. Often they are not symmetrical.

The containers have generally been formed by injection molding or injection stretch blow molding processes that are well known to the industry. The industry has become adept at fashioning decorative ornamentation on the container, but this is generally performed through the molding process, so the ornamentation is formed of the same plastic as the container itself.

A drinking apparatus with a pinched waist is shown illustratively in the U.S. Design Pat. No. D671,793. Another design is shown in U.S. Pat. No. D617,465 for a drinking cup. The pinched waist shape is common in the training cup industry and provides a good illustration of the problem confronting the art, which is the problem of printing on a contoured surface. It is desirable to include decorations to make the contoured cup more aesthetically pleasing to users.

However, the industry has heretofore been generally unable to print decorative images on plastic items having this degree of contour variation. Generally, printing calls for a fairly flat surface or at least one that does not have extreme amounts of curvature. The present invention solves the problem of not being able to print onto an hourglass-shaped or other contoured plastic container.

### BRIEF DESCRIPTION OF THE DRAWINGS

FIG. 1 is an elevation sketch of a resin-based preform used in making a container having printing on highly contoured regions.

FIG. 2 is a representation of a container made from the preform of FIG. 1.

The attached photograph 1 shows an elevational view of a typical preform which is an intermediate article of manufacture used in the illustrative embodiment of a process.

The attached photograph 2 shows an end view of the article in photograph 1.

The attached photograph 3 shows an elevational view of a final article of manufacture according to the illustrative process.

The attached photograph 4 shows elevational views of a preform without printing, the preform with printing, and the final container made from the preform with printing.

### DETAILED DESCRIPTION OF AN ILLUSTRATED EMBODIMENT

A method will now be described of how to manufacture a plastic container having a pinched waist and having printing on the contoured portions. The process begins in the standard fashion where pellets of a desired plastic resin (which is intended herein to include polymers) are loaded into an injection molding machine. A colorizer can be included with the pellets to impart a tint to the product. The pellets may comprise, illustratively, polypropylene, polycarbonate, a copolyester such as “Tritan”™ plastic by Eastman Chemical, other resins, or mixtures thereof.

As has been customary, the injection molding process produces intermediate objects of manufacture referred to in the industry as “preforms.” As shown in FIG. 1, a typical preform 10 includes an open end or “mouth” 12, a neck 14 extending from the mouth and containing a set of threads 16, and a main body portion 18. In plan view it is circular. The main body portion is not highly contoured but includes a closed rounded end 20 which may have a manufacturing remnant 22 located axially at the very tip of the preform 10. Preform 10 may stand, illustratively, ten centimeters (cm.) tall and have a circular mouth opening with a diameter illustratively on the order of six cm. Halfway between remnant 22 and mouth 12, the diameter may be, illustratively, four cm. Above the midpoint, the illustrative preform 10 generally has comparatively little diameter change until reaching the curved closed end 20 which illustratively over an axial distance of approximately two 2 cm. closes the four cm. diameter.

Preform 10 will have been molded by a heat process such as injection molding and formed to the desired shape in the manner conventional in the industry of forming plastic cups. For a taller container, the preform can be taller, and for a wider container, the preform can be wider.

Typically, after the preform is made, according to the traditional process it is then subjected to a further heat-based process of stretch blowing or injection blowing wherein the preform takes on its final shape, but the cylindrical neck portion 14 and threads 16 remain substantially unchanged in dimensions. That is, the remaining portions of preform 10 are molded into any desired shape of a container having the neck 14 with threads 16 and open mouth 12.

In the illustrative embodiment of the process, after the preform has been produced but before it is subjected to further shape modification, printing, i.e., decorative ornamentation, can be applied to the exterior surface of the preform. The ink that is used to make the printing or decorative ornamentation is sometimes called expandable ink or rubberized ink. The inks are based on a thermoplastic polymer, derivatives thereof, or mixtures thereof. Thermoplastic polymers include polypropylene, polyethylene, or polyethylene terephthalate, such as in SPPE/SPPE/SPPF/PET, 1000/1002/2003/2006/3000/3005/3038/4001/4003/4004/4008/5001/6001 (Mixture) available from Dongguan Shun Fu Printing Materials Co., Ltd. located in the Yau Kam Po Industrial Zone, Fenggang Town, Dongguan City in Dongguan, China.

According to embodiments set forth herein, the inks can be the SPP Series of product. The composition and chemical registration number of the inks can be as follows: Resin 60% (CAS 61788-89-4), Solvent 20% (CAS 13070-53-6), Filling 10% (CAS 1317-80-2), Color Toner 10% (CAS 5160-02-1).

In addition to the thermoplastic polymer, the ink can also contain a colorizer such as a colorant, a dye, a pigment, a paint, or mixtures thereof. Examples of a colorant include titanium dioxide or polyacridine dye. The ink can further contain an additive such as a wax, a blowing agent, an alcohol, a hardening agent, a tackifier, a curing agent, an antioxidant, a viscosity agent, a surface treatment agent, or mixtures thereof. Examples of an additive include polyethylene glycol or carnuba wax.

Advantageously the ink is applied to a central region 24 of the preform. In one embodiment, region 24 has a generally constant diameter. The attached Photograph 4 shows two preforms to which ink has been applied.

The ink may be applied illustratively by a standard silk screen process or a standard transfer print process. In the transfer process, the printing is done first on a paper or film and then transferred to the preform. These printing processes are well-known. An adhesive or tape can be used to adhere the ink to the surface of the preform.

The printing is generally in the central region 24 of what will become a pinched-waist shaped final product although good results are obtained with the printing extending to within one cm. of neck 14. In the step of expanding the preform 10 to its final shape, the preform may be converted to any of a wide variety of shapes and may include surface textures if desired.

An optional step of a flame treatment can be performed on the preform, as known in the industry of printing on plastic structures. A flame treatment allows the ink to stick better to the plastic, which, in one embodiment, can be polypropylene.

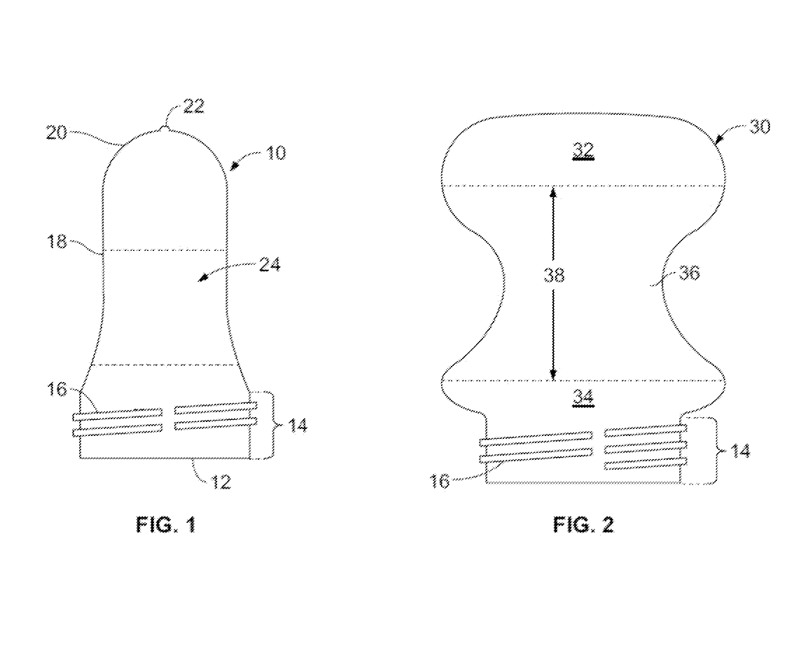

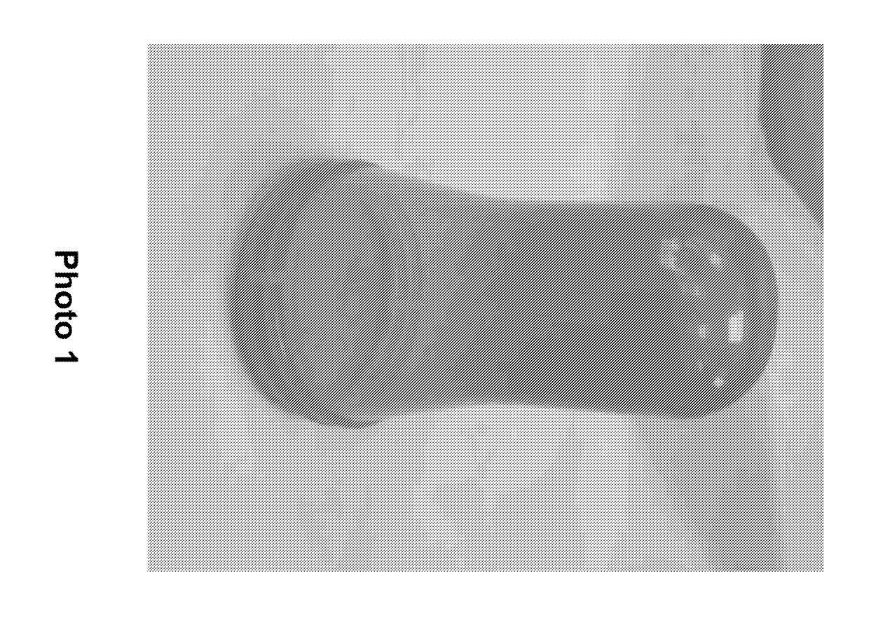

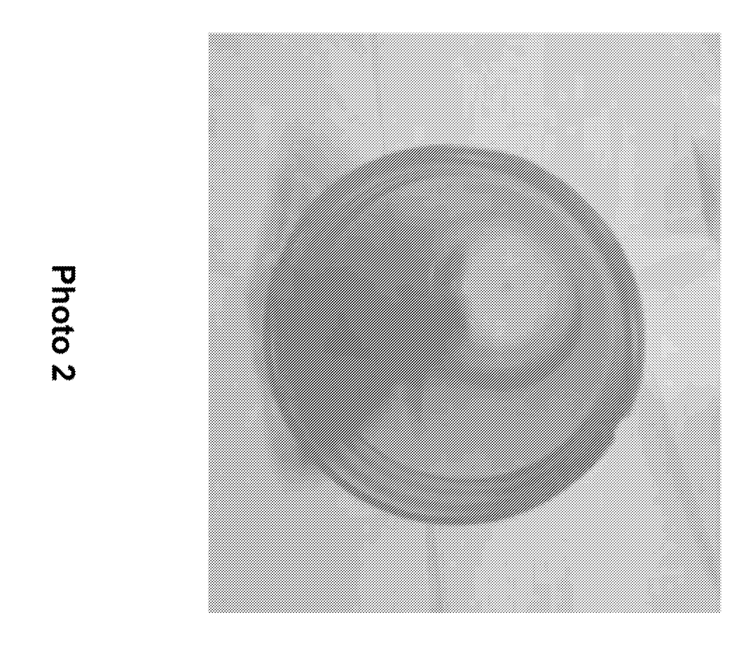

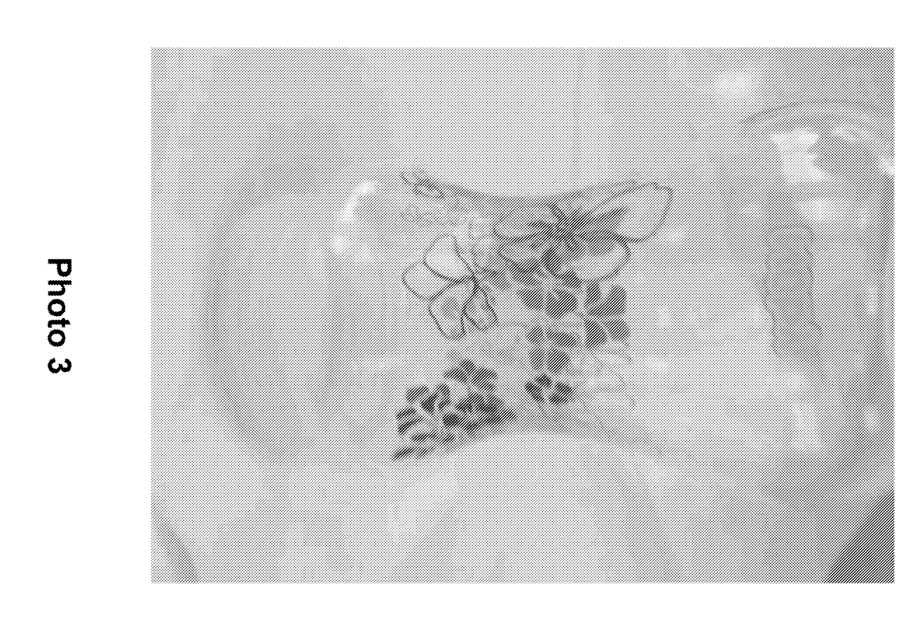

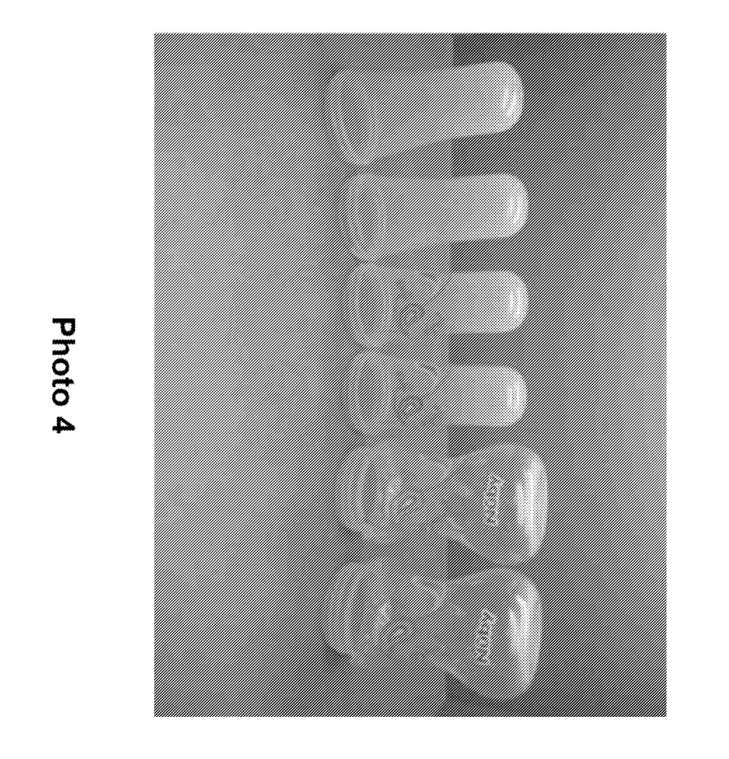

FIG. 2 illustrates a finished container 30 having the same neck portion 14 with threads 16 but having two enlarged portions 32 and 34 located at opposite ends of container 30 and having a pinched waist 36. A central region 38 corresponds to region 24 of the preform and generally contains printing of whatever desired colors and patterns the manufacturer desires. As noted, region 38 may extend close to the neck and may also extend close to the bottom of the container 30. The expandable or rubberized ink applied to or transferred to region 24 expands with the expansion of the preform into region 38 and remains adhered to the container 30.

From the foregoing, it will be observed that numerous variations and modifications may be effected without departing from the spirit and scope hereof. The specific type of plastic is not believed to be critical, but some inks work better with certain resins (plastics). The illustrative ink mentioned herein works well with polypropylene, but other combinations of resin (plastic) and ink that permit expansion and retention of the printing on the expanded, contoured product are within the scope of this disclosure. The size of the container can be varied. It is not essential that the container be sized for a toddler or baby, nor that it have a pinched waist. It may be a drinking cup for an adult, for example. It is to be understood that no limitation with respect to the specific apparatus or processes illustrated herein is intended or should be inferred. It is, of course, intended to cover by the appended claims all such modifications as fall within the scope of the claims.

1. A method of manufacturing a thermoplastic contoured container having decorative ornamentation comprising:
applying decorative ornamentation on a surface of a preform;
shaping the preform having the decorative ornamentation thereon into the contoured container including shaping the decorative ornamentation on the preform surface.

2. The method of claim 1 wherein the preform comprises a structure including an open mouth, a neck, a closed bottom, and a substantially smooth central region between the mouth and the closed bottom.

3. The method of claim 1 wherein the preform comprises a thermoplastic polymer selected from the group consisting of polypropylene, polycarbonate, polyester, copolymers thereof, and mixtures thereof.

4. The method of claim 1 wherein the decorative ornamentation comprises a thermoplastic polymer including an expandable ink, a rubberized ink, or mixtures thereof.

5. The method of claim 1 wherein the surface of the preform comprises an outer surface of the preform.

6. The method of claim 1 further comprising flame treating the preform prior to applying the decorative ornamentation.

7. The method of claim 2 wherein the decorative ornamentation is applied on the substantially smooth central region of the preform between the mouth and the closed bottom.

8. The method of claim 1 wherein the shaping of the preform includes stretching by a blown injection process.

9. The method of claim 1 wherein the contoured container comprises an hourglass shape.

10. The method of claim 4 wherein the thermoplastic polymer comprises a polymer selected from the group consisting of polypropylene, polyethylene, polyethylene terephthalate, derivatives thereof, and mixtures thereof.

11. The method of claim 1 wherein the decorative ornamentation further comprises a surface texture.

12. The method of claim 1 further comprising applying an adhesive to the surface of the preform prior to applying the decorative ornamentation.

13. A preform for manufacturing a contoured decorative container comprising:
an open mouth, a neck, a closed bottom, and a substantially smooth region between the mouth and the closed bottom, and
decorative ornamentation on the substantially smooth region between the mouth and the closed bottom.

14. The preform of claim 13 wherein the decorative ornamentation comprises a thermoplastic polymer including an expandable ink, or a rubberized ink.

15. The preform of claim 13 wherein the preform comprises a thermoplastic polymer selected from the group consisting of polypropylene, polycarbonate, polyester, copolymers thereof, and mixtures thereof.

16. The preform of claim 13 wherein the decorative ornamentation is applied to an outer surface of the preform.

17. The preform of claim 13 wherein preform is stretched by a blown injection process to form a contoured container including decorative ornamentation on the substantially smooth region between the mouth and the closed bottom of the container.

18. The preform of claim 13 wherein the contoured container comprises an hourglass shape.

19. The preform of claim 13 wherein the wherein the decorative ornamentation comprises a polymer selected from the group consisting of polypropylene, polyethylene, polyethylene terephthalate, derivatives thereof, and mixtures thereof.

20. A drinking cup comprising:
a polypropylene container comprising a thermoplastic polymer ink decoration applied on an outer surface of the container wherein the polypropylene and the thermoplastic polymer ink decoration are adhered to each other; and wherein the polypropylene and the thermoplastic polymer ink decoration are stretched to a similar degree to form a shaped container having a thermoplastic polymer ink decoration on the outer surface of the shaped container.
